(19) United States
(12) Patent Application Publication
(10) Pub. No.: US 2015/0347615 A1
(43) Pub. Date: Dec. 3, 2015

(54) Active Web Page Consolidator and Internet History Management System

(71) Applicant: Kevin D. MCGUSHION, (US)

(72) Inventors: Kevin D. McGushion, Simi Valley, CA (US); Christopher Mark Brahmer, Camarillo, CA (US); Pavel Kovalev, Ventura, CA (US)

(21) Appl. No.: 14/760,188

(22) PCT Filed: Jan. 9, 2014
(86) PCT No.: PCT/US2014/010933

§ 371 Date: Jul. 9, 2015

Related U.S. Application Data
(60) Provisional application No. 61/750,746, filed on Jan. 9, 2013.

(51) Int. Cl. G06F 17/30; H04L 29/08

(52) U.S. Cl. CPC G06F 17/30899; H04L 67/02; G06F 17/3089

(57) ABSTRACT

A method for allowing a selection of any portion or all of one or more webpages for conversion and display as an image at a user interface screen and a system for updating the selected portions so that the user is kept up-to-date on changes taking place on the selected webpage URL's without navigating to them. The system periodically queries the webpage to determine if the website has changed, and creates an updates image to replace the image when the website has changed. This method of allowing user selected webpage aggregation onto one or more user accessible pages gives the user the ability to read and overview a multitude of information sources quickly at one location, while using fewer resources compared to opening a plurality of browser instances on the user's computer.

### RELATED APPLICATION DATA

This application claims the priority date of provisional application No. 61/750,746 filed on Jan. 9, 2013.

### BACKGROUND

The present method relates to methods of consolidating web pages, and more particularly, to a method of consolidating web pages by periodically collecting data from a user-selected group of web resources for display to the user.

The number and variety of information sources available to a user on the internet is vast and constantly changing. It is often difficult for a user to frequently visit a list of their favorite websites in a timely manner in order to remain current on information. This is especially true if the user has a large list of web sites she wishes to navigate. It is also difficult for a user to remain current on a large number of favorite sites or to be quickly brought up-to-date on changes by simply navigating to these sites one after the other, since leaving one site to navigate to another will cause them to miss updates at the site they have left. These missed updates may or may not appear or be present the next time the user navigates to the previous site as content on the internet can change quickly.

The user may have many favorite websites, blogs, social sites and other web accessible information sources that they frequent for business or personal use throughout the day. The user may spend large amounts of time navigating from one information source to another in order to get and remain current on changes at those sources. The user may open many tabs in order to quickly switch from one source to another in an attempt to stay current on these many sites. The user may bookmark a multitude sites and navigate to those bookmarks in order to stay informed. All of these solutions require that the user leave a first source of information to go to another and while at the other source, they risk the possibility that important information has changed on sites they are not viewing and if they do not navigate to that site quickly enough that update will be lost. A user may have so many favorite sites that they may lack sufficient time to effectively navigate all of them or may forget to navigate to one or many of them.

The user may employ news aggregators to stay abreast of news and information on the internet. Aggregators typically use RSS (rich site summary or really simple syndication) to present information summaries on the user's personal page. Publishers of information such as news sites, blogs or audio and video providers can choose to syndicate their information on RSS so that the user, usually by way of an aggregation site such as IGOOGLE, PULSE, FLIPBOARD, and the like, may view these summaries or headline information on a single page or multiple pages. A user of an aggregation site may select many information sources which would then be displayed on a page so that updates from many sources can be quickly read and managed.

In order for RSS to operate, a publisher must first post to an RSS feed which is then sent out to users that have requested or subscribed to that feed on their selected aggregation site. The information that a publisher selects to publish may not be the most important or even the most current; and therefor, the feed may not be a reflection of what is current on the publisher's actual site or most recent in the world of information. RSS feeds may not be prioritized in a hierarchical manner and stories that are less news worthy can be placed ahead of those that are more important. While an RSS user may be able to select a feed source, they cannot select the exact portions of a site that get published and may have to endure many undesired feeds and summaries before receiving one that is needed. It is possible that important information may be delayed by a publisher to an RSS feed as they may choose to prioritize placement of that information elsewhere. Finally, many publishers on the internet simply do not provide RSS feeds, especially more esoteric sites or sites traditionally not thought of as requiring information feeds, such as shopping, couponing, hobby and other consumer based sites and interests.

Compounding the difficulties of the aforementioned solutions is the dramatic shift from desktop and laptop computers to portable devices such as smart phones and tablets and even wearable portable devices which access internet based information. These portable devices can often experience difficulty in connecting to the internet as they have no hard connection and rely on wireless data transfer through 3G, 4G, and the like. When these devices are within a Wi-Fi hotspot or wireless computer network, connectivity and speed of data transfer is generally not a concern, but this type of service may not always be available. By their very nature, these devices are meant to be portable and a user may be in areas where there is no Wi-Fi access and poor cell reception. In these cases, navigating modern websites, which often have home pages from one to several megabytes, can be very time consuming, problematic, or even impossible. Further complicating this problem are the numerous animations, videos, or sound bites which may run on a site and require even more bandwidth and time to load. Furthermore, computer resources are used to maintain multiple open browsing sessions, which slows the performance of the computer.

What is needed is a method of allow a user to easily select only the portions of website that are important to them for organization and presentation on an internet based page or pages. This method must allow the user to quickly view important information from many sources at one location. The user selected sites or portions of sites that have been organized on their page must be refreshed frequently enough so that the user can be kept up-to-date on the latest information on any site or portion of site selected in near real time. The data required to download this information must be kept to a minimum in order to accommodate rapid updates as well as overcome the limitations of poor or spotty cell coverage when a Wi-Fi network is unavailable, especially for mobile devices such as smart phones, tables and wearable devices.

### SUMMARY OF THE INVENTION

A method of providing content to a user is described herein. The steps of the method includes communicating a resource address from a user input on a local computing device to a remote server system and inserting or enqueuing the resource address into a queue. The resource address is dequeued in a first cycle and communicated to a web browser instance. The web browser instance builds a site page associated with the code provided by the resource address. Then, at least a portion of the site page is converted into an image file, where the image file is visually representative of the site page when the image file is displayed. The image file is communicated to the local computing device and displayed on a screen of the local computing device.

The resource address is reinserted into the queue at any point in time after the resource address has been dequeued in the first cycle. Then, the resource address is dequeued in a subsequent cycle. The resource address is communicated to the web browser instance, where an updated site page associated with the resource address is built within the web browser instance. At least an updated portion of the updated site page is converted into a updated image file, where the updated image file is visually representative of the updated site page when the updated image file is displayed.

Optionally, an image coordinate system may be defined on the image file. A plurality of crop instruction coordinates are received, where the crop instruction coordinates define a selected portion of the image file to be displayed on the local computing device. Then, the image file is cropped as defined by the crop instruction coordinates. Further, a user coordinate system may be defined within a graphical user interface. Then, the selected portion of the image file is positioned to a desired coordinate on the graphical user interface. An association between the desired coordinate and the selected portion is stored on a database.

Optionally, the crop instruction coordinates may be stored on a database. Then, the crop instruction coordinates may be applied to the updated image file to define an updated selected portion. The updated image file may be cropped as defined by the user instruction coordinates. The selected portion of the image file and the updated selected portion of the updated image file may be stored on the database. A graphical user interface tool may be provided which permits the user to toggle between the selected portion and the updated selected portion, such as a sliding icon, a button icon, of other graphical or alphanumeric command.

Optionally, the image file and the updated image file may be stored on the remote server system. Then, the image file may be converted into a hash value; and the updated image file may be converted into an updated hash value. The hash value is compared to the updated hash value to determine if the hash value is different than the updated hash value due to a content change at the resource address between the first cycle and the updated cycle. The updated image file may be communicated to the local computing device if it is determined that the hash value is different than the updated hash value. An updated selected portion of the updated image file may be displayed on the screen of the local computing device in place of the image file.

Optionally, the queue may be a priority queue, such that a higher priority resource address can be inserted above a lower priority resource address to facilitate earlier communication of the image file to the local computing device. A database may be checked to determine if the resource address received from the local computing device is already associated with an existing image file stored on the database. If the resource address is associated, then the resource address is identified as low priority. If the resource address is not associated, then the resource address is identified as high priority.

Optionally, the remote server system may be comprised of a web server, a queue server, a capture server, and a database, either physically or virtually separated. The resource address may be communicated from the local computing device to the web server of the remote server system. The resource address may be communicated from the web server to the queue server for insertion into the queue. The resource address may be communicated to the capture server for building within the web browser instance and for converting the site page into an image file. The image file may be communicated from the capture server to the database for storage. The image file may be communicated from the database to the web server. The image file may be communicated from the web server to the local computing device.

Optionally, at least one of a page down command and a scroll command may be communicated to the resource address, such that an entire height of the site page can be converted to the image file. Again optionally, the unit of the coordinate system may be set to correspond to a dimension of a pixel in the image file.

Optionally, a second resource address may be communicated from the user input on the local computing device to the remote server system. The second resource address may be inserted into the queue and is later dequeued. The second resource address may be communicated to the web browser instance. Then, a second site page associated with the second resource address is built within the web browser instance. At least a second portion of the second site page may be converted into a second image file, where the second image file being visually representative of the second site page when the second image file is displayed. The second image file may be communicated to the local computing device. And, a second selected portion of the second image file may be displayed on the screen of the local computing device with the selected portion of the image file.

Optionally, the image file and the updated image file may be stored on a database. And, a graphical user interface tool may be provided, which permits the user to toggle between the image file and the updated image file. The graphical user interface tool may be a sliding icon element. The updated image file is displayed when the sliding element is in an initial position. The image file is displayed when the sliding element is repositioned to a second position. Optionally, the selected portion includes at least a part of the image file and the updated selected portion includes at least a part of the updated image file.

### BRIEF DESCRIPTION OF THE SEVERAL VIEWS OF THE DRAWINGS

Additional objects and features if the method will be more readily apparent from the following detailed description and appended claims when taken in conjunction with the drawings, in which:

FIG. 1 shows the site where the application resides and the user interface screen before tiles have been added;

FIG. 2 shows the user interface screen after the ‘Add Tile’ button has been selected;

FIG. 3 shows the user interface screen in which a user specified site URL has been entered;

FIG. 4 shows the user interface screen presenting a captured image of a user specified site URL;

FIG. 5 shows the architecture of the capture service when an image of a site URL has been requested;

FIG. 6 shows the use of multiple web browsers in the capture server;

FIG. 7 shows a pixel based X, Y coordinate system being superimposed on a captured site URL image;

FIG. 8 shows user selected framing of a portion of the captured site URL image using pixel based X, Y coordinates;

FIG. 9 shows a pixel based X, Y coordinate system being superimposed on the user interface screen;

FIG. 10 shows the user selected portion of the captured site URL being located and placed in the coordinate system of the user interface screen;

FIG. 11 shows multiple user specified site URL's being placed on the user interface screen;

FIG. 12 shows the architecture of the capture service when repeated images are taken of a site URL for updating;

FIG. 13 shows the queue server with a stack of URL sites to be captured;

FIG. 14 shows the queue server with a stack of URL sites to be captured where the URL most recently captured is placed back on the stack; and

FIG. 15 shows a web browser being opened in the interface screen.

### LISTING OF REFERENCE NUMERALS OF FIRST-PREFERRED EMBODIMENT

100 main graphical user interface screen
105 URL of the service
110 top menu bar
120 add tile button
130 vertical scroll bar
140 vertical scroll button
150 horizontal scroll bar
160 horizontal scroll button
170 viewing area
200 add tile window
210 URL entry field
220 capture URL button
230 suggested URL's
240 sliding tool
300 user requested URL
400 captured URL image
410 second story
420 third story
430 fourth story
440 first story
450 URL title
500 capture service
505 web server
515 database
520 world wide web
525 capture server
530 queue server
600 web browser
700 x axis
710 y axis
720 x axis origin
730 y axis origin
740 last point on x axis
750 last point on y axis
800 image frame
810 x axis image frame start location
815 frame start point
820 x axis image frame end location
825 frame end point
840 y axis image frame end location
850 y axis image frame start location
900 main screen x axis origin
910 main screen y axis origin
915 main screen x axis
920 main screen x axis last point
925 main screen y axis
930 main screen y axis last point
1010 x axis main screen placement location
1015 first image placement point
1020 y axis main screen placement location
1110 x axis main screen placement location
1115 second framed image
1120 y axis main screen placement location
1125 third framed image
1130 second image placement point
1135 third image placement point
1300 first site URL
1310 second site URL
1320 third site URL
1500 web browser

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

Accordingly, the present method provides an easy to use graphical interface for a user to capture, frame, organize and view selected portions of websites, while they are refreshed at a rate which allows the user to remain up-to-date in near real time on their important websites.

This is accomplished by providing a web based site to load a recently captured image of a user specified web site URL (uniform resource locator). Tools are provided to allow the user to frame the portion or portions of a site they wish to have displayed on their user interface screen. The framing specifications unique to that user and selected URLs are saved to a server for later retrieval and use. Tools are also provided to allow the user to organize multiple framed selections of web sites on a page or pages of their user interface screen for best viewing. These tools allow for movement, placement and sizing of framed portions of selected sites and a means for reframing the same to include additional information or exclude unwanted information. These various preferences in sizing and placement are also saved to a server for later retrieval and use.

The framed portion or portions of the user specified URLs are loaded onto a user interface screen when the user visits their personalized site. This is accomplished by capturing a recent image (usually in bitmap format) of a URL site or sites specified by the user and applying the saved framing, sizing and placement settings to the newly retrieved image or images. This process or capturing, framing, sizing and placing of URL sites is repeated often enough and images of the same refreshed on the user interface screen so that any time a user visits their user interface screen, they are presented with the most recent information of their one or many site URLs for quick review.

From the user's interface screen, they are able to select the framed site causing the web browser to automatically open a tab and navigate to that URL site or alternatively, opening a frame or portal to the sites URL within the user interface screen giving the user full access to information they had been made aware of at their home page.

The present method comprises a web based application with the substantial portion of the executable code and processing taking place happens at remote servers, thus reducing the work load at a user's device. However, this method may include allocating or breaking up tasks so that processing may be shared between remote servers and a user's device or all of the processing may be handled at the user's device.

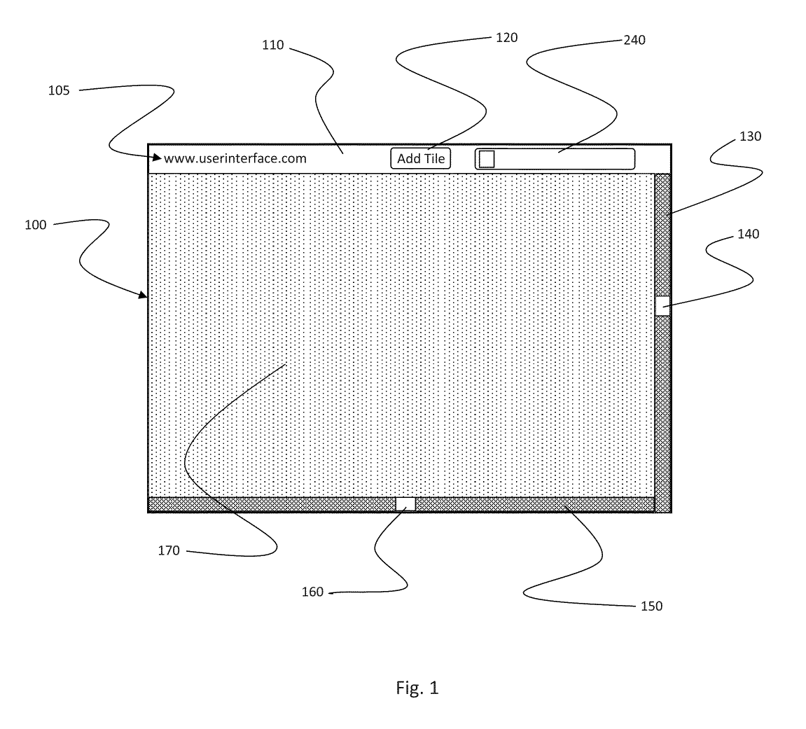

FIG. 1 shows an illustration of the graphical user interface known as the application screen in a preferred embodiment. This screen may be accessed from a device with internet access or this screen may work in conjunction with a software application that either partially or fully resides on the device being used to access the web based service. This screen is comprised of the main graphical user interface screen (100) having been directed to the web location where the service is resident by way of the URL of the service (105) which is shown in the top menu bar (110).

In the top menu bar there is an “Add Tile” button (120) which activates the process of adding a tile. Vertical scroll bar (130) with vertical scroll button (140) is located on the right side of the main graphical user interface screen and allows images not visible in the viewing area (170) and located above or below the viewing area (170) to be viewed by sliding the vertical scroll button (140) in the direction of the hidden image located off the visible page. The horizontal scroll bar (150) with horizontal scroll button (160) allows images locate to the left or right but outside of the viewing area to be viewed by sliding the horizontal scroll button (150) in the direction of the hidden image.

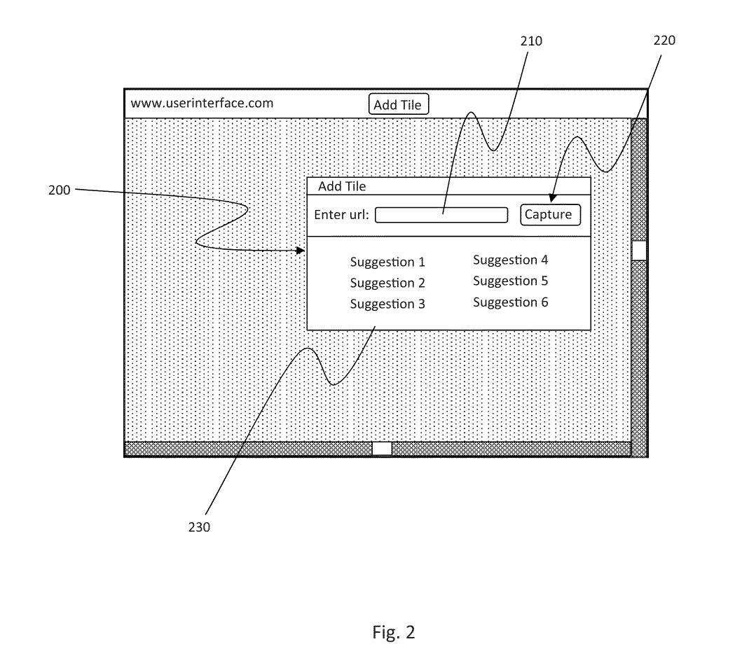

FIG. 2 shows the add tile window (200), on the main graphical user interface screen (100). The add tile window (200) having been requested by selecting the add tile button (120). Within the add tile window (200) are three areas or features, the first is the URL entry field (210), where a user may enter the address of any navigable URL for capture. The second is the capture URL button (220) which when selected causes an image of the URL to be captured. And the third is a list of suggested URL's (230) which a user may select from in order to quickly begin creating URL captures. The list also serves to help educate users to the different types of websites that exist. This list may have many categories such as news, shopping, weather, travel, cars and many more.

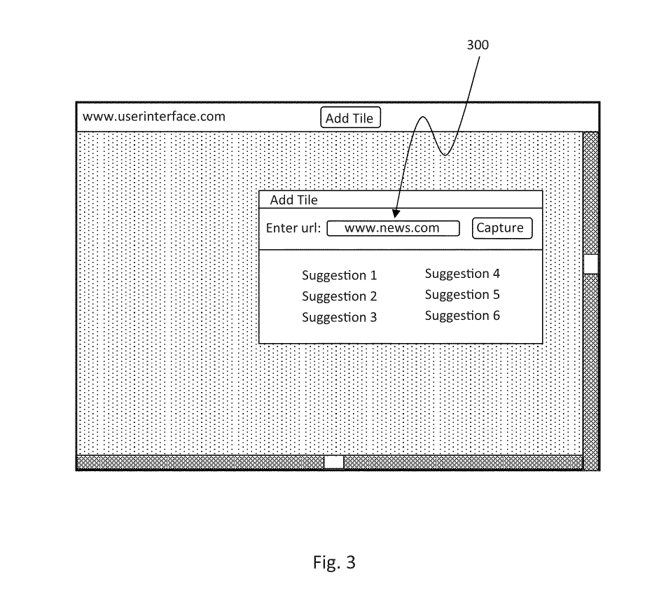

FIG. 3 shows a specific URL (300) address that has been entered in the URL entry field (210). A user may enter a URL that is not on the list of suggested URL's (230) or one that is on the list. If the URL is on the list, predictive text functions may be used that predict the desired URL based on the characters that have been entered. For instance, if a user has entered the letters “new”, it may be predicted that the users wishes to enter “news” or “New York”. The predictions may be based on URL's in the list of suggested URL's (230), URL's stored in memory that other users have requested, or a generic list of words, names or URL's known to exist on the internet. By selecting the capture URL button (220), the process of capturing an image of that URL begins.

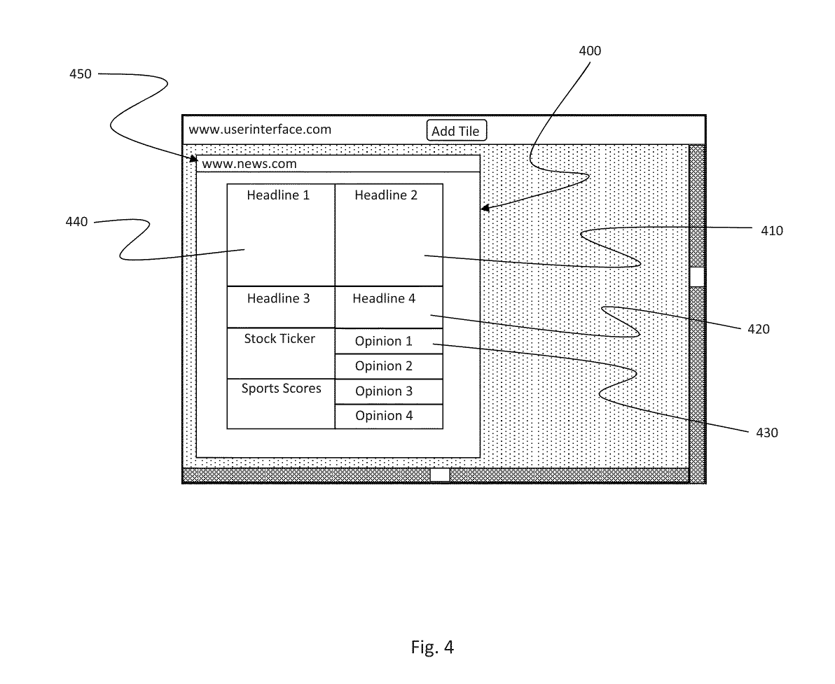

FIG. 4 shows the captured URL image (400) after it has been captured and presented in the main graphical user interface screen (100). This captured image may be of any website URL and may have many components or areas of interest to the user. For the purposes of this example, a news URL has been selected and several headlines such as first story (440), second story (410) and third story (420) are visible. An example of a news opinion piece is shown in fourth story (430). The image captured may have many sections and some may be of interest to a user and some may not. It is possible that the entire page is of interest to the user.

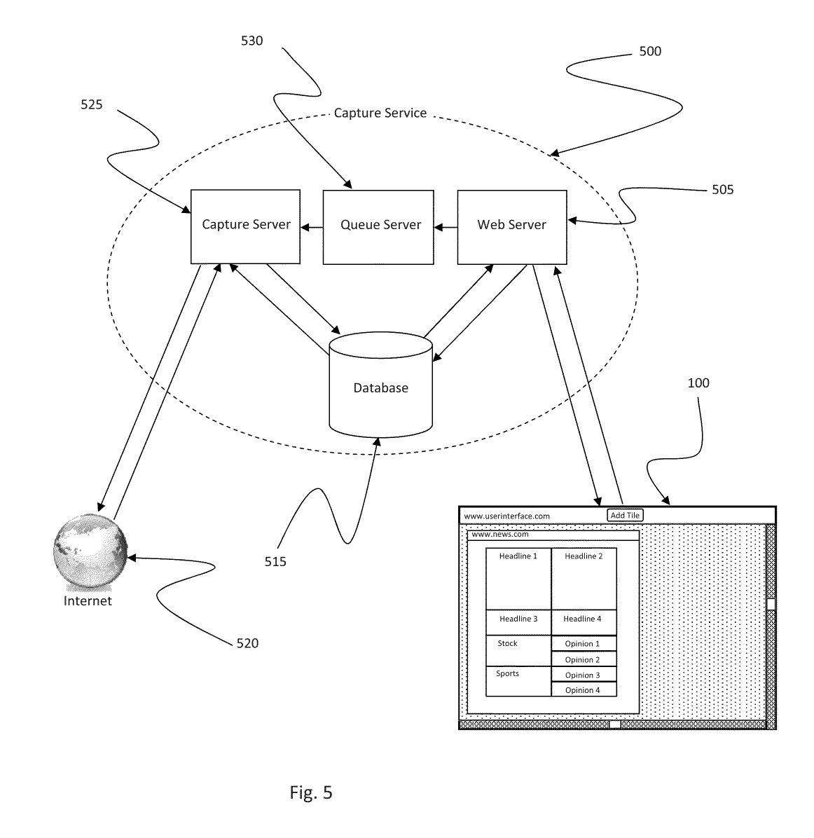

FIG. 5 shows a logical flow of the process to obtain captured URL image (400) for viewing and use by the user. The structure of this process and the methods used show only one preferred method and many such methods may be possible to accomplish the same task. This description is not meant to limit the or otherwise exclude other methods that may accomplish the same task. This method is also described as being a web based service in its preferred embodiment where the capture service (500) and other tasks are handled at remote servers and the presentation of the final information is presented at the main graphical user interface screen (100). However, this method may also be accomplished by utilizing a user's device processor and or resources to perform all or a part of the same operations described in this preferred embodiment. Any or all of the functions described in the capture service (500) may be broken into additional sub tasks or combined into larger tasks. The server task allocations described may be virtual or physical depending on the type of equipment and or software being used.

At the core of FIG. 5 is the capture service (500). The capture service (500) is comprised of several basic functions, the web server (505), the queue server (530), the capture server (525), and the database (515). When a request is made by a user from the main graphical user interface screen (100) for a URL image, the web server (505) receives this request. The webserver (505) will first check the database (515) to see if an image of the requested URL has already been captured, as would happen if another user had previously requested the same URL or if the URL were on the list of suggested URLs (230). If the image is stored in the database (515), then that image is returned to the user for display on the main graphical user interface screen (100). If the image is not in the database (515), then the web server sends the URL to the queue server (530). The capture server operates multiple simultaneous occurrences of web browsers. Each occurrence of a web browser receives a URL to capture from the queue server. The internet browser goes to the internet and captures the requested URL web page and may also execute a series of commands while loading the web page in order to get a more complete image of that page, such as scroll, page up, or page down commands.

The database stores all user settings, preferences, selected URLs, the coordinates to frame each tile, the placement coordinates of each tile in the canvas grid, the desired size of each tile, background color, as well as the most recent captures the users specified tiles and a history of captured tiles to serve the internet history management system. The database also stores the most recent captures of all user requested URLs as well as stored URLs from suggested sites and others that may be entered.

The queue server is tasked with queuing up one or more capture servers (525). It maintains a list of URL's to be captured; and as the capture server (525) captures the URL image, the capture server (525) takes the next URL off the stack in the queue server (530). If there is only one capture server (525) then the task of capturing URL's place in the queue server (530) will take place in series (or one capture after the other). For example, a list of URLs is stored on the queue server (530), which represent the requested URL's from a plurality of users. The capture server (525) can sequentially capture each URL one at a time as the requested address is received by the queue server (530). Once a URL on the list has been captured, that URL can be placed on or near the bottom of the list. In this way, a cycle of web capturing is created, where each URL on a list can be refreshed by a new capture as the queue server (530) cycles through the list. The list can change dynamically, as users request new URL's not currently on the list or if all users remove a URL from their requested sites. All tasks may be resident on a single piece of hardware and virtually separated or divided among separate pieces of hardware.

However, more rapid progress can be made in capturing URL images if multiple capture servers (525) are used and the work is performed in parallel. The queue server (530) can also be used to prioritize more important URLs for immediate capturing. If a user has request the capture of a new URL whose image does not reside in the database (515), then that image can be placed at the front of the queue for immediate capture, reducing the amount of time that a user will wait for a first image. Further, more popular URLs or URLs that change more frequently may be biased to the top of the list, for example using a priority queue. Since capturing a URL requires greater resources than is required by the queue server (530), it is generally desirable to create a system with multiple capture servers (525) being coordinated by a single queue server (530). This system can be expanded so that there are multiple subsystems comprising one queue server (530) with one or more capture servers (525).

Some web pages only load content immediately visible by the screen viewing it and will not necessarily load content “below the fold” or content lower than what can be viewed by a screen of that particular size. While the web page is never actually viewed by a human at this point nor is it displayed on a screen, a default screen size is used for the sake of satisfying display requirements. Since a customer may require content outside this screen view and it may not have loaded, a series of commands is executed to simulate viewing of content outside the screen view at the top of a web page or content below the fold. Commands such as page down are enough to cause the site to more fully load. By commanding a page down the web site is caused to believe that lower content is being viewed. This page down command may be made as many times as is necessary in order to load the full page or at least the desired content. After paging down a corresponding page up will follow to return the page to the top of the screen. This page down and up command may be executed a number of times or as necessary in order to fully populate the page with content. Other commands may also be used to more fully load pages such as a delay before an image is taken in order to give sufficient time for the page to fill with content. Once the page has loaded according to these procedures which can be applied in various ways and may include additional commands, a PNG image capture of the web page is taken.

The Capture Server then compares this PNG image of the site to the last image it took of the same site, which may have been only a few seconds prior and which still reside on in the Database. This comparison algorithm uses hashing technology, where the string of data representing the image and comprised of ASCII characters is converted to a string of unique numbers (usually of shorter length) according to a formula. This string of hash numbers from a first newer image having just been captured is compared to the string of hash numbers of the second older image in the database if they are the same the older image is not replaced and is deem a current image and the URL is returned back to the queue in the Queue Server by the Web Server to be captured again. If the hash strings are different, than the older image is replaced with the newer image with the conclusion being made that the image just captured is more current. Again the URL is returned back to Web Server to be so that it may be placed back into the queue of the Queue Server. If there is no image file of that URL in the database, than it is a new capture and is sent to the database and again returned back to Web Server to be so that it may be placed back into the queue of the Queue Server. This process repeats its cycle perpetually so that constant updating of tiles is possible and the user may be presented with the most current data. Of course the length of the queue, the time to capture and the number of occurrences of web browsers in the Capture Server combine to give an over queue time. This time can be as short as a few seconds and as long as minutes depending on load. These loads are balanced by closely monitoring the queue length and average capture time of the URL's as well as specific capture times. If a previously good URL which had yielded a capture takes too long to capture its image, it is removed from Capture Server and placed back in the queue. If this URL fails to capture repeatedly it is placed in a holding area in the Database for evaluation. In this way the Capture Service continues to run efficiently.

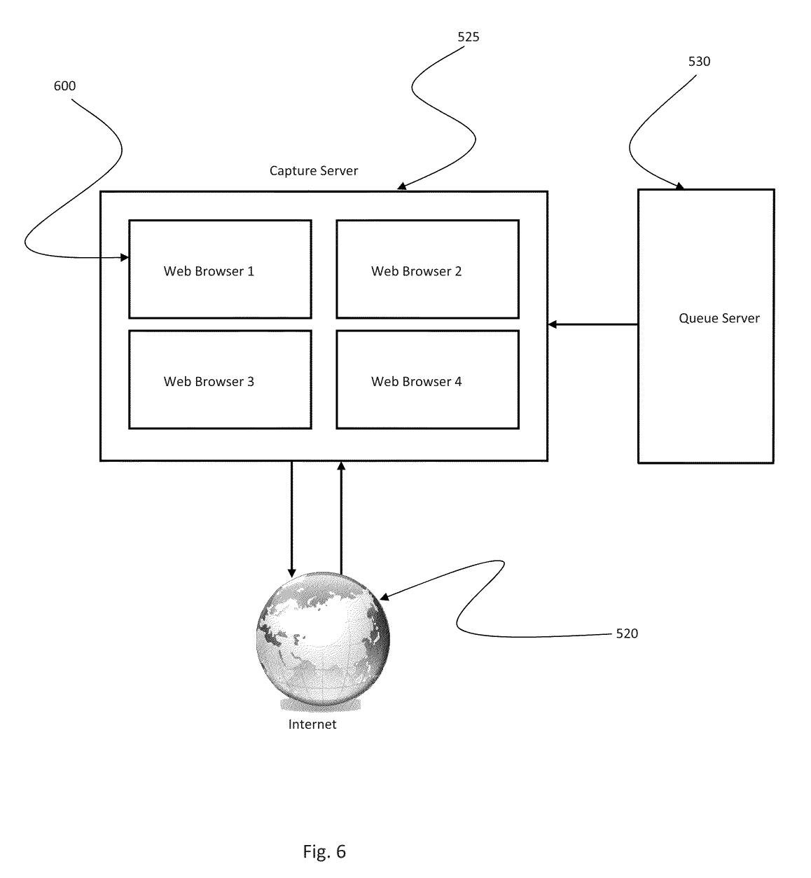

Referring to FIG. 6, the capture server (525) has at least one version of a web browser (600) and quite often many versions of a web browser such as FIREFOX, INTERNET EXPLORER, or SAFARI operating within it. The web browser (600) having taken a request for a URL from the queue server (530) proceeds to go to the internet (520) to make a captured URL image (400) of the site by making a GET request to check the sites viability. GET is a standard computer request made of any site to check if the site exists and if its information is OK. If the site is OK then the HTML (hyper text markup language) code is retrieved from the URL site and the web browser (600) begins to build the site page according to the HTML code provided. Once the site URL is fully assembled within the browser, a screen shot of the site is taken by the capture server (525). This screen shot is in the form of a bitmap type image such as PNG, JPEG or GIF with the preferred image type being PNG (portable network graphics) or JPEG (joint photographic experts group). The resolution of this image can vary but one common resolution is 800 pixels wide by 600 pixels high. The height can vary greatly depending on the height of the web site URL assembled using the HTML code. If the image is a JPEG and image has 3 bytes of color then the total raw image size is 1.44 MB. Using compression that size of this file cane be reduced greatly and 1/10^{th} compression is common making the 1.44 MB image 0.144 MB or 144 KB. This freezing of the site image and subsequent compression helps transfer large amounts of website information to portable devices and will be discussed in greater detail below.

The capture server performs another important task; it frames the portion of the total image capture of a URL according to user specifications in order to make a tile or tiles, these user specifications having been stored in the database in folders for particular users. Since more than one user may be requesting a tile of that same URL, the capture server checks the database for the framing requirement of all users requesting tiles of that URL and creates the appropriate tiles accordingly, with a time stamp on each and stores them in the specific user files of the database.

Once a captured URL image (400) is made from a site, it is sent to the database (515). The web server (505) having continued to make periodic requests of the users desired captured URL image (400) now finds an image to return to the user. This image is then sent to the user for display on the main graphical user interface screen (100).

In doing this process, a site which could require several megabytes to load and require constant connection to the internet and use of bandwidth to execute animation, video and audio can now be delivered to a user with minimal bandwidth and connectivity and with greatly increased speed.

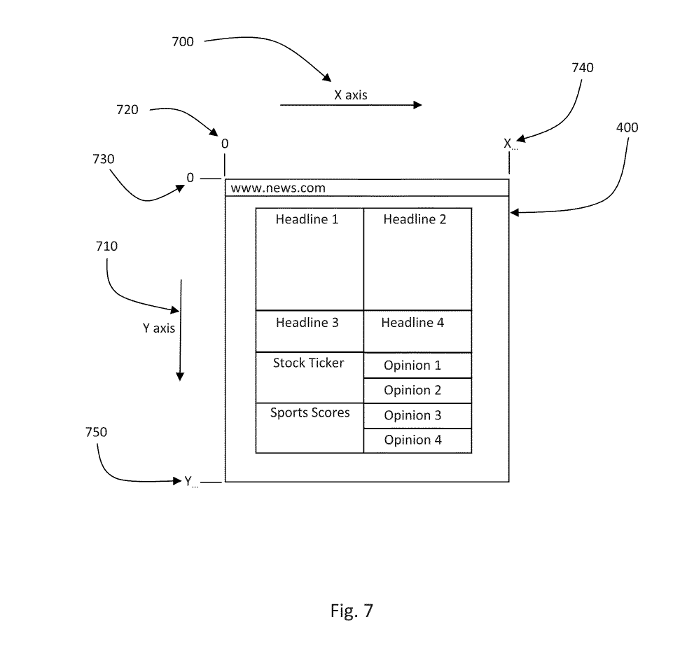

In order to further streamline data usage and to eliminate unwanted information, the user has the ability to present only the portion of the whole captured URL image (400) that they wish to see on their main graphical user interface screen (100). Referring to FIG. 7, the captured URL image (400) has a grid system super imposed over it where the pixels which make up the image represent individual graduations of the grid system. This grid system creates a coordinate system where the number of pixels in the width of the image represents the length of the x-axis (700) and the number of pixels in the height of the image represents the height of the y-axis (710) with each pixel representing one unit along both the x-axis and the y-axis. By establishing the upper left corner of the image as the x-axis origin 720 and y-axis origin (730) the origin (which are assigned the coordinates of 0,0 in the present example) of the coordinate system can be established. The width of image runs to the right from origin (730) and along the x-axis (700) and the height of the image runs down from the origin (730) and along the y-axis (710).

The last point on the x-axis (740) may be defined as the maximum pixel width of the captured URL image (400); and the last point of the y-axis (710) may be defined as the maximum pixel height of the captured URL image (400). If for example, the captured URL image (400) is 800 pixels wide and 600 pixels high then the total width of the x-axis (700) is 800 units with 800 being the last point on the x-axis (740) and the total height of the y-axis (710) is 600 units with 600 being the last point on the y-axis (750). By using this system it becomes possible to locate desired items on the captured URL image and to create borders to include only the portions of the image the user desires. Many other types of coordinate systems may be employed at this point to accomplish the same task however; pixels are used as a preferred method because of its natural association to the image and convenience.

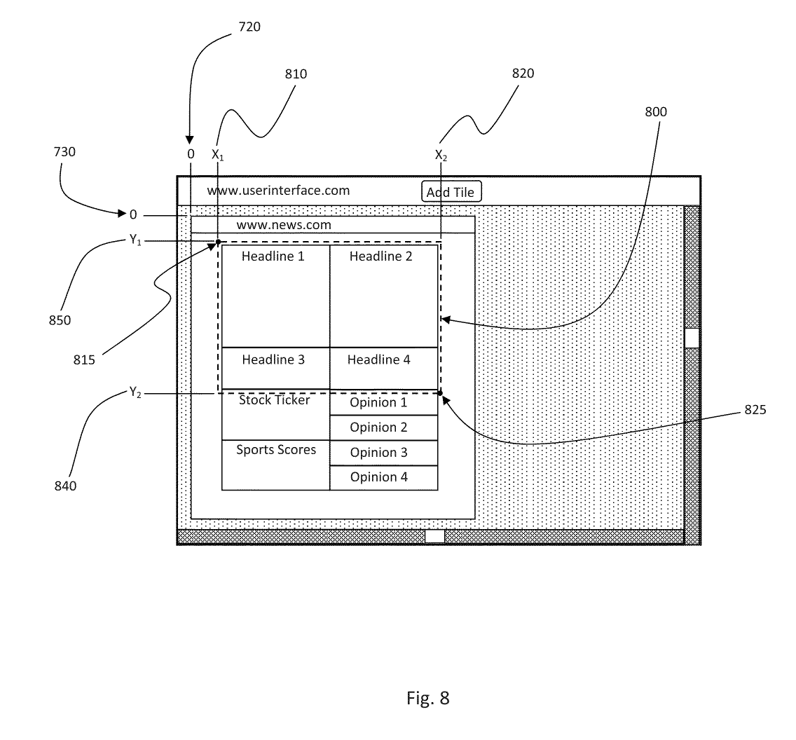

Using the coordinate system described above and referring to FIG. 8, an image frame (800) can be created of the captured URL image (400) in the main graphical user interface screen (100). Once the image is captured and presented to the user on the main graphical user interface screen (100), a default framing tool is presented to the user so that by either using finger action on a touch screen or by using a mouse or touchpad on a desktop computer the image frame (800) can be sized to include the portions of the captured URL image (400) the user wishes to see on their main graphical user interface screen (100). Although, the image frame (800) is shown as being rectangular, other user selected shapes are possible, such as variation of an L-shape, circular shapes, custom or hand-drawn frame shapes, and the like.

Once the x-axis origin (720) and y-axis origin (730) have been established, the framing of the image can be accomplished with respect to this primary origin. By first selecting an x-axis image frame start location (810) and a y-axis image frame start location (730), a frame start point (815) can be defined as the upper left point of the image frame (800). Using finger motion on a touch screen or mouse movement on a computer or other appropriate selection means, a frame end point (825) can be established. The width of the frame may be defined as the x-axis image frame end locator (820) minus (−) the x-axis image frame start location (810); and the height of the frame may be defined as the y-axis image frame end location (840) minus (−) the y-axis image frame start location (850). Upon completing the image frame (800) all information outside the defined frame is removed or cropped using known software tools. The image frame (800) specification is unique to a particular user, and this data in the form of the URL identity and associated coordinates is saved in database (515) for later retrieval.

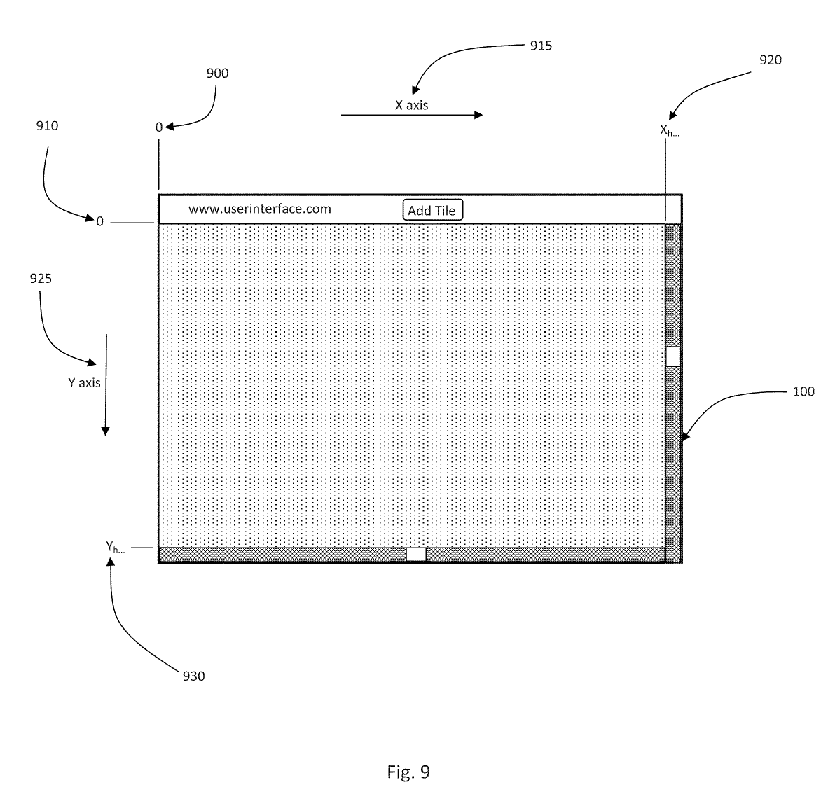

Referring to FIG. 9 and the main graphical user interface screen (100), the size of this screen can vary depending on the device the user employs to access the URL of the service (105). Typically device manufacturers define their screen size in terms of pixels. For example, an APPLE IPHONE 5 has a pixel resolution of 1136 pixels by 640 pixels; and a SANSUNG GALAXY 3S has a resolution of 1920 pixels by 1080 pixels. Because a user can place the image frame (800) of the captured URL image (400) anywhere on the main graphical user interface screen (100) as desired, it is important to establish a coordinate system for the device screen so that location may be saved to the database (515) allowing the user to view their placed image in the same location every time they visit the URL of the service (105). To accomplish this, the device screen which is made known electronically to the service when a user visits the service is separated into a main screen x-axis (915) and a main screen y-axis (925). The origin of the screen is set at the upper left corner of the usable space on the screen. The usable space would exclude things like the top menu bar. The main screen x-axis origin (900) may be defined as the left most location of the main screen; and the main screen x-axis last point (920) may be defined as the last point on the main screen x-axis (915). This main screen x-axis last point (920) corresponds to the maximum screen width in pixels of the device. The main screen y-axis origin (910) may be defined as the upper most location of the main screen that is usable to the user; and the main screen y-axis last point (930) may be defined as the last point on the main screen y-axis (925). This main screen y-axis last point (930) corresponds to the maximum screen height in pixels of the device. This establishes the preferred method for creating a coordinate system on the main graphical user interface screen (100). Other methods and units may be used and various scaling methods may be employed to keep the true location of an image frame (800) in the same location irrespective of screen resolution. Such scaling for instance would place the upper left corner of an image if it were placed in the center of the screen of an APPLE IPHONE 5 at (568px, 320px) if the same user access their service from a SAMSUNG GALAXY 3S the upper left corner of the same image would appear at (960px, 540px).

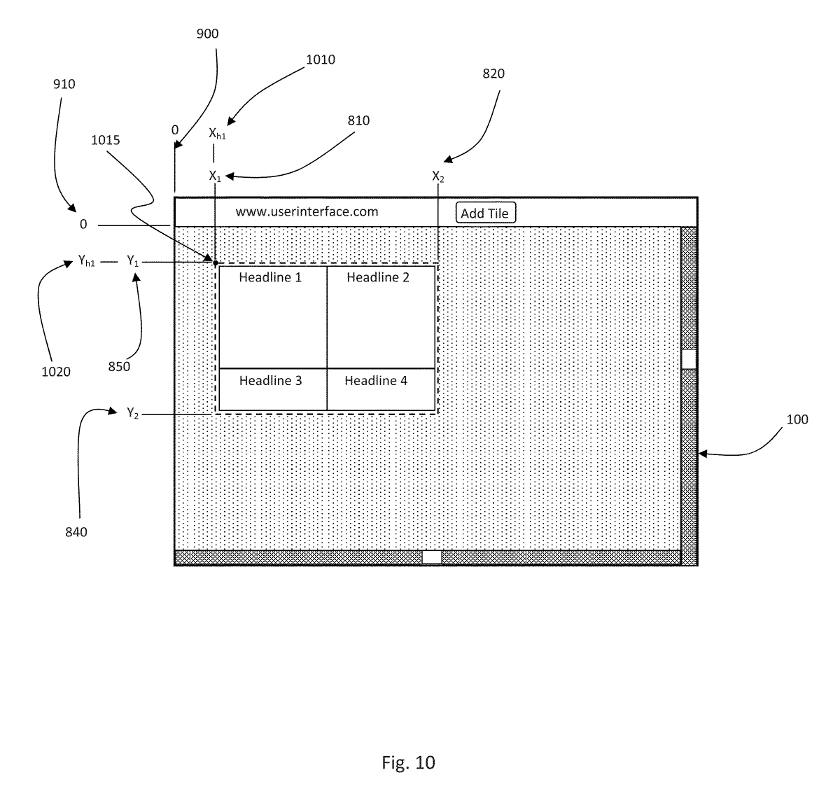

By combining the two coordinate systems described above, one for the user defined image frame (800) and the other for the main graphical user interface (100), the user can place their image frame (800) anywhere on the main graphical user interface (100) and the service having stored this information in database (515). Thus, the user can expect to find the placement of images in the correct location whenever they visit the service. Referring to FIG. 10, this is accomplished by recording the user placement of image frame (800) in the main graphical user interface screen (100) by saving the point at which the frame start point (815) is placed in the main graphical user interface screen (100) and coincides with the x-axis main screen placement location (1010) and the y-axis main screen placement location (1020). This location defining the first image placement point (1015). For orientation purposes the x-axis image frame end location (820) extends to the right of the first image placement point (1015) and the y-axis image frame end location (840) extends below of the first image placement point (1015).

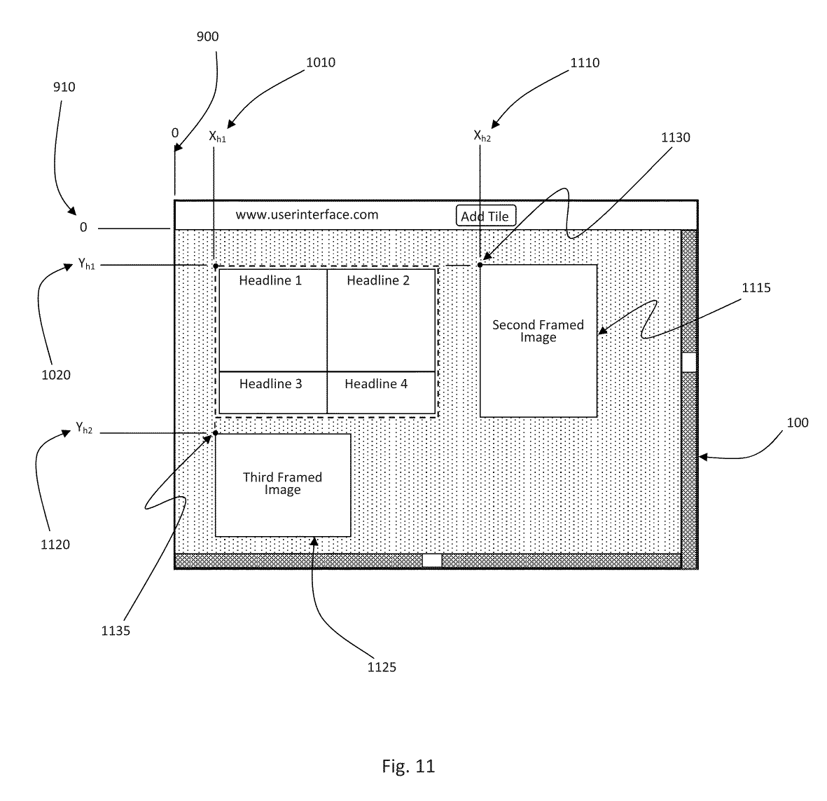

FIG. 11 shows an expansion of the method defined thus far and illustrates the placement of a second framed image (1115) at second image placement point (1130) which is coincident with second framed image x-axis location (1110) and the placement of a third framed image (1125) at third image placement point (1135) which is coincident with third framed image y-axis location (1120). This process may be repeated as many times as the user wishes to create a page where they will be able to find all their favorite web sites framed according to their specifications and place on their main graphical user interface screen (100). Being web accessible this information may be accessed from any device with internet access anywhere in the world.

Many design features can be employed which improve usability and user customization. For instance a general border can be been placed between the framed images or tiles to give visual separation. This general border can of course be any width and it may be omitted entirely depending on preferences. A visually appealing corner radius can been added to each tile to give a more finished look. This radius can have different radii or the corner of the tile may be finished with a chamfer of various sizes or some other visually appealing shape. Also the tiles may have an additional adjacent border immediately around or adjacent to all or selected tiles to add effects such as a three-dimensional look or a highlighting effect of various sorts. These adjacent borders can be user customizable in terms of effect, size, design and color, texture or any other desirable design characteristic. The general border likewise may be customizable in effect, size, design and color, texture or any other desirable characteristic.

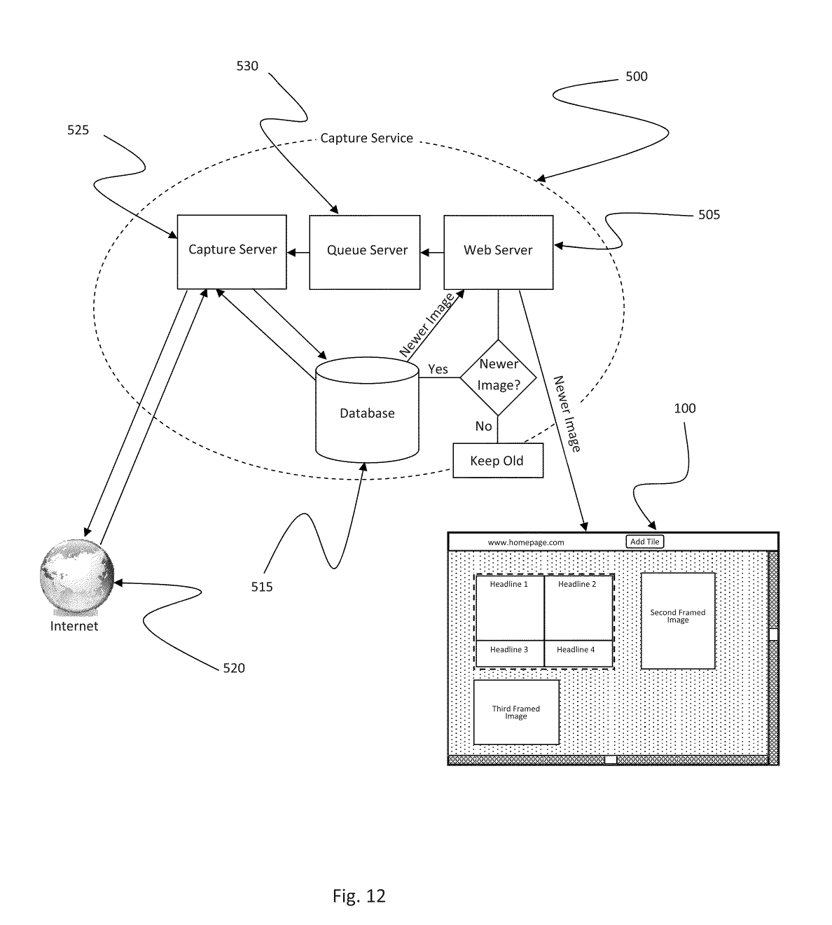

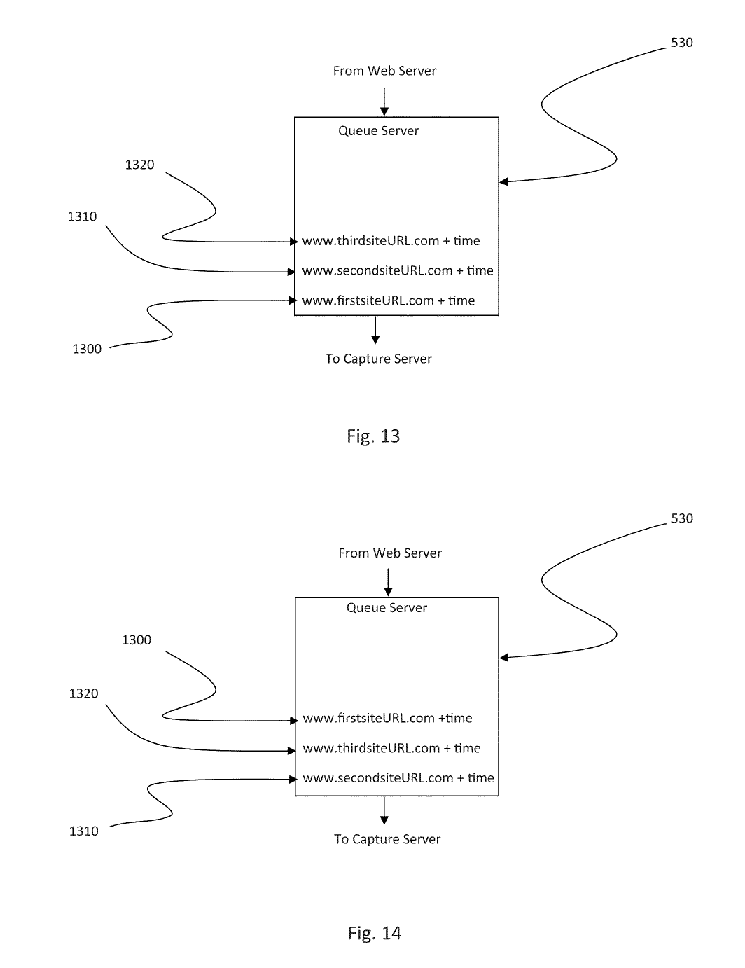

Referring to FIG. 12, where the process of updating the framed images of (800, 1115, and 1125) on the main graphical user interface screen (100) is shown. This process works in conjunction with the queue server (530) shown on FIGS. 13 and 14. FIG. 13 shows a first site URL (1300), a second site URL (1310), and a third site URL (1320) in sequence in the queue server (530) and presenting these sites to be captured in this order to capture server (525). Once the capture server (525) has captured the image of a next requested site URL, that URL is placed back on the stack or list of URL's to be captured by the capture server (525).

FIG. 14 shows the first site URL being placed back on the stack of URL's to be captured thus causing the entire stack of URLs within the queue server (525) to be continually recaptured in the order of stack placement. In this way, newer images of a site URL will be continually fed to the database (515) and older images replaced with newer images as they are made available by the capture server (525). In order to track the recentness of an image being captured a time stamp is added to the image name being saved in the data base. In this way, it will be known to the web server (505) whether a new image of a user specified site URL is available. The number of URL's in the stack and the speed with which the capture server (525) can capture images of individual site URL's dictates the total cycle time of the stack and hence the refresh rate of any of the URL's in the stack. This refresh rate may be may be decreased, providing faster URL updates by reducing the number of URL's on the stack or by capturing URL site images faster. This architecture of the capture service (500) may be scaled to include as many services as is necessary to capture URL sites in a time that provides the timeliest information to users. Within the capture service (500), any server may be scaled in number of size to best accomplish the task and separation of the tasks may be physical or virtual or may be made more granular according to tasks being performed or less granular.

Referring again to FIG. 12, logic is added to the capture service (500) to take advantage of newer images being captured and stored in the database (515). The web server (505) accessing the complete list of user requested site URLs from database (515), makes continual checks of the database (515) for a newer image of a user requested site URL by comparing the time stamp on the image current being displayed on the main graphical user interface screen (100) with the time stamp of the image of the same site URL being held in database (515). If a newer image is available it is delivered to the web server (505) for immediate delivery to the main graphical user interface screen (100) where it is inserted at the users specified location and according to their sizing requirements and replacing the older image. In this way, the user is given a continuous stream of refreshed images of their requested site URLs that have been modified and placed according to their specifications keeping them fully up-to-date on all of their favorite sites.

The above process can be scaled to include as many users as necessary, where use of usernames and passwords stored in database (515) allows for organization and mass modification of images, according to user specified settings so that exact customization of information specified by a user can be maintained. Of course this method may be expanded to include millions of users with millions of URL's being captured all being framed according to the users specifications and placed on their graphical interface screen at the users specified location. For example, a single URL image can be captured and distributed to numerous subscribed users, with each user only receiving the portion of the URL image framed by that user. Thus, even though only one URL image is captured on each cycle with this example, one user may receive the upper right corner of the URL image, while a second user may receive the upper left corner of the URL image. The user's device may receive the entire captured image and display only the selected frame; or the user's device may receive just the framed portion of the image to save on bandwidth and resources.

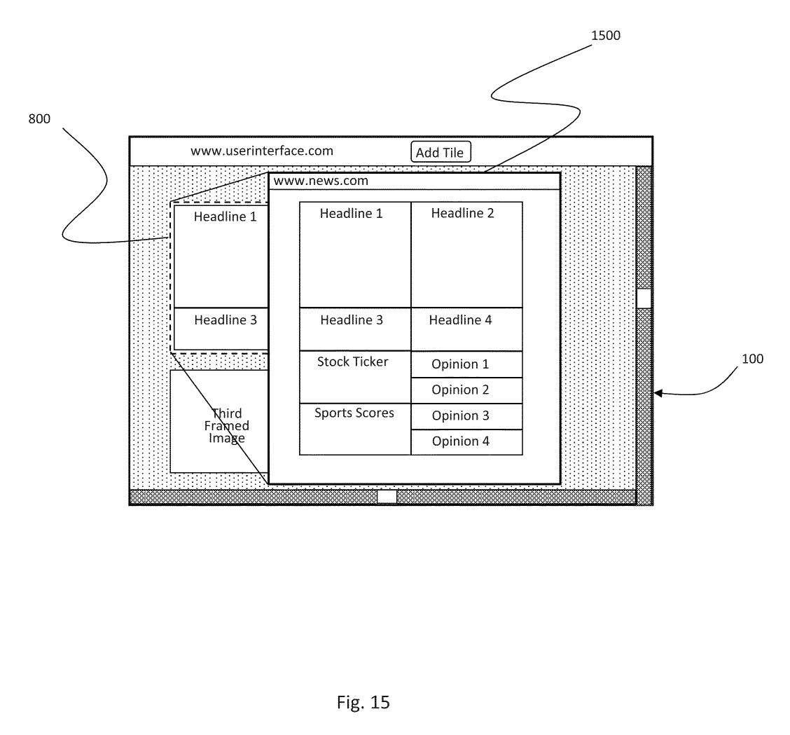

Referring to FIG. 15, if a user is made aware of an update on news or important information through continual refreshing of the main graphical user interface screen (100), a user may want to visit the actual site for a more detailed review of information at the site URL. Since the physical area occupied by a framed image on the graphical user interface screen (100) is known and the site URL associated with that image is also known, a user may touch, click or otherwise select any portion of the area of the framed image and the user can be directed to the actual site. Selecting image frame (800) causes the graphical user interface screen (100) to open a web browser within is screen thereby navigating to the selected site URL for more detailed review by the user. The user may navigate to other locations within this browser or they may close the browser returning to the continually updating main graphical user interface screen (100). Browsing of selected framed images may be accomplished in a number of other ways including the opening of a tab in a browser or opening a browser which hides the main graphical user interface screen in the background.

When a user has missed a news story or wishes to find out what existed on their tiles in the past, they can use the internet history management system to review the historical images captured for those sites by retrieving the saved tile images which have been stored in the database. This is done through a sliding tool (240) integrated as part of the users home page and is shown in with a close-up of the tool in FIG. 1. The system is capable of saving tiles which have been captured and framed for as long as necessary or desirable. If, for instance, the capture queue is arranged such that the capture cycle time interval is 60 seconds that means it is possible to store the history of the tiles on a home page in increments of 1 minute. The system provides an sliding tool (240) to allow a user to slide a bar back along a time line thereby identifying the point in history they would like to see the archived or saved tile images. As the bar is slid back (to the right in this illustration) the system begins to retrieve stored images of the user's tiles sequentially and chronologically so that at a particular moment in history to tiles will be displayed as they were when that moment occurred. This tool may slide through 1 hour, 25 hours, many days, weeks even years, depending on preferences by the user and software settings. The system, the capture service and the database storage of historical tiles may be configured such that almost any time interval can be stored as well as any time duration from only minutes to many years.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A method of providing content to a user, the method comprising the steps of:
communicating a resource address from a user input on a local computing device to a remote server system;
inserting the resource address into a queue;
dequeueing the resource address in a first cycle;
communicating the resource address to a web browser instance;
building a site page associated with the resource address within the web browser instance;
converting at least a portion of the site page into an image file, the image file being visually representative of the site page when the image file is displayed;
communicating the image file to the local computing device;
displaying the image file on a screen of the local computing device;
reinserting the resource address into the queue;
dequeueing the resource address in a subsequent cycle;
communicating the resource address to the web browser instance;
building an updated site page associated with the resource address within the web browser instance; and
converting at least an updated portion of the updated site page into a updated image file, the updated image file being visually representative of the updated site page when the updated image file is displayed.

2. The method of claim 1, further comprising the steps of:
defining an image coordinate system on the image file;
receiving a plurality of crop instruction coordinates, the crop instruction coordinates defining a selected portion of the image file to be displayed on the local computing device; and
cropping the image file as defined by the crop instruction coordinates.

3. The method of claim 2, further comprising the steps of:
defining a user coordinate system within a graphical user interface;
positioning the selected portion of the image file to a desired coordinate on the graphical user interface;
storing an association between the desired coordinate and the selected portion on a database.

4. The method of claim 2, further comprising the steps of
storing the crop instruction coordinates on a database;
applying the crop instruction coordinates to the updated image file to define an updated selected portion; and
cropping the updated image file as defined by the user instruction coordinates.

5. The method of claim 4 further comprising the steps of:
storing the selected portion of the image file to the database;
storing the updated selected portion of the updated image file to the database; and
providing a graphical user interface tool which permits the user to toggle between the selected portion and the updated selected portion.

6. The method of claim 1 further comprising the steps of:
storing the image file on the remote server system;
converting the image file into a hash value;
storing the updated image file;
converting the updated image file into an updated hash value; and
comparing the hash value to the updated hash value to determine if the hash value is different than the updated hash value due to a content change at the resource address between the first cycle and the updated cycle.

7. The method of claim 6 further comprising the steps of:
communicating the updated image file to the local computing device if it is determined that the hash value is different than the updated hash value; and
displaying an updated selected portion of the updated image file on the screen of the local computing device in place of the image file.

8. The method of claim 1, wherein the queue is a priority queue, such that a higher priority resource address can be inserted above a lower priority resource address to facilitate earlier communication of the image file to the local computing device.

9. The method of claim 8 further comprising the steps of:
checking a database to determine if the resource address received from the local computing device is already associated with an existing image file stored on the database;
identifying the resource address as low priority if the resource address is associated; and
identifying the resource address as high priority if the resource address is not associated.

10. The method of claim 1, wherein the remote server system comprises a web server, a queue server, a capture server, and a database.

11. The method of claim 10 further comprising the steps of:
communicating the resource address from the local computing device to the web server of the remote server system;
communicating the resource address from the web server to the queue server for insertion into the queue;
communicating the resource address to the capture server for building within the web browser instance and for converting the site page into an image file;
communicating the image file from the capture server to the database for storage;
communicating the image file from the database to the web server; and
communicating the image file from the web server to the local computing device.

12. The method of claim 1 further comprising the step of:
communicating at least one of a page down command and a scroll command to the resource address, such that an entire height of the site page can be converted to the image file.

13. The method of claim 2, wherein the step of defining the coordinate system further includes the step of:
setting the unit of the coordinate system to correspond to a dimension of a pixel in the image file.

14. The method of claim 1 further comprising the steps of:
communicating a second resource address from the user input on the local computing device to the remote server system;
inserting the second resource address into the queue;
dequeueing the second resource address;
communicating the second resource address to the web browser instance;
building a second site page associated with the second resource address within the web browser instance;
converting at least a second portion of the second site page into a second image file, the second image file being visually representative of the second site page when the second image file is displayed;
communicating the second image file to the local computing device;
displaying a second selected portion of the second image file on the screen of the local computing device with the selected portion of the image file.

15. The method of claim 1 further comprising the steps of:
storing the image file on a database;
storing the updated image file on the database; and
providing a graphical user interface tool which permits the user to toggle between the image file and the updated image file.

16. The method of claim 15 wherein the graphical user interface tool is a sliding element, the method further comprising the steps of:
displaying the updated image file when the sliding element is in an initial position; and
displaying the image file when the sliding element is repositioned to a second position.

17. The method of claim 1 wherein the selected portion includes at least a part of the image file and the updated selected portion includes at least a part of the updated image file.
